(19) United States
(12) Patent Application Publication
(10) Pub. No.: US 2021/0049550 A1
(43) Pub. Date: Feb. 18, 2021

(54) Mobile Shop and System

(71) Applicant: Xuezhi Zhang, Guangzhou (CN)

(72) Inventor: Xuezhi Zhang, Guangzhou (CN)

(21) Appl. No.: 16/790,737

(22) Filed: Feb. 14, 2020

(30) Foreign Application Priority Data
Aug. 14, 2019 (CN) 201910752814.3

(51) Int. Cl. G06Q 10/08; G06Q 50/28; G06Q 20/32; G06Q 20/20; H04W 4/40

(52) U.S. Cl. CPC G06Q 10/08355; G06Q 10/0832; G06Q 50/28; H04W 4/40; G06Q 20/322; G06Q 20/206; G06Q 10/087

(57) ABSTRACT

The present invention discloses a mobile shop, which is comprised of a retail or shopping server running the shopping information system and a properly designed vehicle equipped with one or several retail equipments and ID coded goods with bar code, two dimensional bar code, QR code or RFID tags stocked on goods shelves on board, the retail equipments can communicate with the retail or shopping server to process retail transactions or provide retail service through 5G or other wireless communication technology; the mobile shop provides a substitute to entity shops during the shopping virtualization on the internet, saving operation cost for shops by reducing rental expenses and human resources expenses, at the same time providing convenience to customers.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to the information system for a mobile shop.

With the rapid development of communication and technology, shopping become more and more virtual via the internet. The operating cost for entity shops are becoming higher and higher owing to the high cost of rental expenses and human resources. During the process of shopping virtualization on the internet, mobile shops and unmanned mobile shops based on 5G or other wireless communication technology are good choices as substitutes. Moreover, mobile shops provide more convenience for shoppers.

### BRIEF SUMMARY OF THE INVENTION

The present invention is to build a mobile shop by equipping a properly designed vehicle that can move around with retail equipments based on 5G or other wireless communication technology such as bar code and two-dimensional bar code scanners, RFID readers and POS machines etc. and ID coded goods with bar code, two dimensional bar code or QR code or RFID tags orderly stocked on goods shelves on board the vehicle. The retail equipments on the vehicle can communicate with the retail or shopping server which runs the shopping information system to process various retail transactions and provide retail services through 5G or other wireless communication technology. The POS machines can communicate with the servers of the paying banks and receiving banks to process payments through 5G or other wireless communication technology.

The vehicle for the mobile shop can be an unmanned robotic vehicle, an automatic driving vehicle, a normal vehicle with a driver or it can be a manned automatic driving vehicle. Shop staff or assistants can be assigned on duty on board the vehicle; or no shop assistant is assigned on duty on the vehicle; or shop service robots or robotic shop assistants can be equipped on the vehicle to provide services.

### DETAILED DESCRIPTION OF THE INVENTION

The present invention put forwards the business mode and system for a mobile shop. The mobile shop is built by equipping a properly designed vehicle that can move around with retail equipments based on 5G or other wireless communication technology such as bar code and two-dimensional bar code scanners, RFID readers and POS machines etc. and ID coded goods with bar code, two dimensional bar code or QR code or RFID tags orderly stocked on goods shelves on board the vehicle. The retail equipments on the vehicle can communicate with the retail or shopping server which runs the retail or shopping information system to process various retail transactions and provide retail services through 5G or other wireless communication technology. The POS machines can communicate with the servers of the paying banks and receiving banks to process payments through 5G or other wireless communication technology.

The mobile shop can cruise along fixed routes to provide services at fixed places at fixed times; it can also go to an appointed place at an appointed time for service according to a customer's appointment; it can also drive to places where people gather for events to provide service; it can also drive around and stop for service at customers' requests; it can also provide service to customers on board the vehicle while driving; it can of course provide services with various combinations of the services mentioned above.

There can be several mobile shops servicing at different routes at the same time; there can also be several mobile shops going to different appointed places to provide services for different customers or different places where people gather for events.

The power supply for the retail equipments on board the vehicle can be from the engine or battery sets of the vehicle; it can also be from high density Lithium battery sets or hydrogen fuel cells equipped on board the vehicle.

The system for the mobile shop in the present invention includes a properly designed vehicle equipped with retail equipments based on 5G and other wireless communication technology such as bar code and two-dimensional bar code scanners, QR code scanners, RFID readers and POS machines etc. and ID coded goods with bar code, two dimensional bar code or QR code or RFID tags orderly stocked on goods shelves on board the vehicle and a retail or shopping server that runs the retail or shopping information and management system processing retail transactions and providing retail services. The retail equipments on board can communicate with the retail or shopping server through 5G or other wireless communication technology to process retail transactions and/or provide retail services. The driving system of the mobile shop can communicate with the retail or shopping server through 5G or other wireless communication technology to control the vehicle. The retail or shopping server can be a cloud computing server or a normal server.

The doors of the mobile shop can be opened automatically when stopped for service; it can also be opened by shop member cards, or by random password assigned when making appointments, or by face recognition of customers. The door opens automatically for shoppers to leave when payment for purchase is made.

The start up and stop for service of the mobile shop can be controlled by the driver or shop staff on duty on board; they can also be controlled remotely by the control center of the shopping information and management system. The start up and stop for service of the mobile shop with an unmanned robotic vehicle is controlled remotely by the control center of the shopping information and management system or by control staff.

The POS machines used for the mobile shop includes bank card POS machines, shop member card POS machines, face recognition POS machines, biometric POS machines, QR code POS machines, encrypted currency POS machines and NFC POS machines etc.

The above technical schemes include the preferred technical scheme of the present invention, but the present invention also covers various variants of the above technical schemes according to the innovative thoughts, ideas or concepts of the present invention, e.g. the mobile shop can be staffed with shopkeepers or equipped with robotic shopkeepers; the mobile shop can be equipped with shopping advisor (can be AI) that recommends bargain items to member customers; the mobile shop can also be equipped with computers, client machines and pads on board. For another example, the door can be opened by face recognition of customers or by finger print verification. The information system in the above technical schemes can be a cloud computing system with server and Apps (shorted as A/S system); it can also be a B/S (Browser/Server) system or a C/S (Client/Server) system.

The present invention can be employed in any general purpose or special purpose computing environments or computing systems. Examples of applicable known computing systems, computing environments and/or computing configurations for the present invention include, but not limited to, personal computer, server computer, special purpose computers including POS computers, portable or laptop equipment, handsets, multiple processor systems, systems based on micro-processors, set top box, programmable consumer electronic appliances, network personal computers, small computers, large scale computers, cloud computing systems (A/S: App/Server), B/S systems, C/S systems and distributed computing environments which contain any systems and/or equipments described above, etc.

The present invention makes use of the cutting edge technologies such as 5G, AI, robotics, robotic/automatic driving etc. to create a mobile shop as a substitute for entity shops during the process of shopping virtualization through the internet so as to save rental and human resources cost for entity shops and to serve customers in a customer-focused manner.

### Detailed Embodiment

Further description of the present invention is made in the following section with two preferred embodiments.

Preferred Embodiment One: This preferred embodiment is to build a mobile shop by equipping a properly designed vehicle that can move around with retail equipments based on 5G or other wireless communication technology such as bar code and two-dimensional bar code scanners, QR code scanners, RFID readers and POS machines etc. and ID coded goods with bar code, two dimensional bar code or QR code or RFID tags orderly stocked on goods shelves on board the vehicle. The retail equipments on the vehicle can communicate with the retail or shopping server which runs the shopping information system to process various retail transactions and provide retail services through 5G or other wireless communication technology. The POS machines can communicate with the servers of the paying banks and receiving banks to process payments through 5G or other wireless communication technology. The vehicle for the mobile shop is a vehicle with a driver. There are shop assistants on board the vehicle on duty to provide services to customers. The mobile shop cruises along fixed routes and stops at fixed places on fixed times for service to customers. The door of the mobile shop opens automatically when stopping to provide service to customers.

Preferred Embodiment Two: This preferred embodiment is to build a mobile shop by equipping a properly designed vehicle that can move around with retail equipments based on 5G or other wireless communication technology such as bar code and two-dimensional bar code scanners, QR code scanners, RFID readers and POS machines etc. and ID coded goods with bar code, two dimensional bar code or QR code or RFID tags orderly stocked on goods shelves on board the vehicle. The retail equipments on the vehicle can communicate with the retail or shopping server which runs the shopping information system to process various retail transactions and provide retail services through 5G or other wireless communication technology. The POS machines can communicate with the servers of the paying banks and receiving banks to process payments through 5G or other wireless communication technology. The vehicle for the mobile shop is an unmanned robotic vehicle or a manned automatic driving vehicle. No shop assistant is assigned on duty on the vehicle; but shop service robots can be equipped on board the vehicle. The mobile shop can drive to appointed place at appointed time to provide service to customers who make the appointment. In the process of driving to the appointed place, the mobile shop can keep in contact with the customer who makes the appointment by telephone or instant messages. The door of the mobile shop opens for service to the customer with the appointment through face recognition of the customer or opens with a random password assigned during appointment; it also opens for a customer to leave when payment for purchase is made. The mobile shop can also drive to places where people gather for events to provide services; the door opens with a shop member card or bank card for service in this case, it also opens for a customer to leave when payment for purchase is made.

The embodiments above are examples provided for general technicians in the field to realize the present invention. Technicians in the field can make changes or modifications to the embodiments described above in accordance with the creative thoughts of the present invention. Therefore the scope of the present invention will not be limited by the above embodiments, but will be extended to the maximum extent in accordance with the creative characteristics put forward in the claims.

1. A mobile shop, comprising:
a properly designed vehicle equipped with one or several retail equipments and ID coded goods with bar code, two dimensional bar code, QR code or RFID tags stocked on goods shelves on board the vehicle, wherein the retail equipments can communicate with the retail or shopping server that runs the shop information system to process retail transactions or provide retail services through 5G or other wireless communication technology.

2. The mobile shop of claim 1, wherein the vehicle for the mobile shop can be a normal vehicle with a driver, or can be an unmanned robotic vehicle or automatic driving vehicle, or can also be a manned automatic driving vehicle.

3. The mobile shop of claim 1, wherein the retail equipments include bar code scanners, two dimensional bar code scanners, QR code scanners, RFID readers and various POS machines based on 5G or other wireless communication technology; the POS machines include bank card POS machines, shop member card POS machines, face recognition POS machines, biometric POS machines, QR code POS machines, NFC POS machines and encrypted currency POS machines.

4. The mobile shop of claim 1, wherein there can be several mobile shops servicing at various routes at the same time, there can also be several mobile shops going to different appointed places or places where people gather for events to provide service.

5. The mobile shop of claim 1, wherein the mobile shop can be staffed with shop assistants, or no shop assistants is assigned on board the mobile shop, or the mobile shop can be equipped with robotic shop assistants.

6. The mobile shop of claim 1, wherein the door of the mobile shop can open automatically when stopping to provide service, the door can also be opened by bank cards, shop member cards or by face recognition of a customer or by entering a password assigned randomly during appointments; the door opens for customers to leave when payment for purchase is made.

7. A system for a mobile shop, comprising:
a retail or shopping server that runs the shopping information system;
and a properly designed vehicle which is equipped with one or several retail equipments and ID coded goods with bar code, two dimensional bar code, QR code or RFID tags stocked on goods shelves on board the vehicle, the retail equipments can communicate with the retail or shopping server to process retail transactions or provide retail services through 5G or other wireless communication technology.

8. The system of claim 7, wherein the vehicle for the mobile shop can be a normal vehicle with a driver, or can be an unmanned robotic vehicle or automatic driving vehicle, or can also be a manned automatic driving vehicle.

9. The system of claim 7, wherein the retail equipments include bar code scanners, two dimensional bar code scanners, QR code scanners, RFID readers and various POS machines based on 5G or other wireless communication technology; the POS machines include bank card POS machines, shop member card POS machines, face recognition POS machines, biometric POS machines, QR code POS machines, NFC POS machines and encrypted currency POS machines.

10. The system of claim 7, wherein there can be several mobile shops servicing at various routes at the same time, there can also be several mobile shops going to different appointed places or places where people gather for events to provide service.

11. The system of claim 7, wherein the mobile shop can be staffed with shop assistants, or no shop assistants is assigned on board the mobile shop, or the mobile shop can be equipped with robotic shop assistants.

12. The system of claim 7, wherein the door of the mobile shop can open automatically when stopping to provide service, the door can also be opened by bank cards, shop member cards or by face recognition of a customer or by entering a password assigned randomly during appointments; the door opens for customers to leave when payment for purchase is made.

13. The mobile shop of claim 1, wherein the mobile shop can cruise along fixed routes and stop at fixed places to provide service, or cruise and stop to provide service at customer's request, or drive to appointed places at appointed times to provide service to customers who make appointments, or drive to places where people gather for events to provide service, or provide service to customers on board the vehicle during cruising, or provide service with a combination of the service modes mentioned above.

14. The system of claim 7, wherein the mobile shop can cruise along fixed routes and stop at fixed places to provide service, or cruise and stop to provide service at customer's request, or drive to appointed places at appointed times to provide service to customers who make appointments, or drive to places where people gather for events to provide service, or provide service to customers on board the vehicle during cruising, or provide service with a combination of the service modes mentioned above.
